(19) United States
(12) Patent Application Publication
(10) Pub. No.: US 2012/0124834 A1
(43) Pub. Date: May 24, 2012

(54) METHOD FOR MANUFACTURING A FORGED PART WITH ADAPTIVE POLISHING

(75) Inventors: Stéphane Cholet, Le Plessis Bouchard (FR); Bertrand Lamaison, Issy Les Moulineaux (FR); Xavier Malassigne, Vaux Sur Seine (FR); Arnaud Villanova, Migoaloux-Beauvoir (FR)

(73) Assignee: SNECMA, Paris (FR)

(21) Appl. No.: 13/380,988

(22) PCT Filed: Jun. 23, 2010
(86) PCT No.: PCT/EP2010/058946

§ 371 Date: Jan. 31, 2012

(30) Foreign Application Priority Data
Jun. 26, 2009 (FR) 0954398

(51) Int. Cl. B23P 15/02; B21K 3/04; B23Q 17/20

(52) U.S. Cl. 29/889.7; 29/407.09

(57) ABSTRACT

A method for manufacturing a part by forging, including producing a semifinished part by precision forging and polishing the part by an abrasive strip, compliant geometric characteristics of the part to be obtained being predetermined in a theoretical model. The method includes: measuring the geometrical characteristics of the semifinished part after the forging operations and comparing the characteristics with the theoretical model; determining noncompliant areas on the surface of the part; determining the amount of material to be removed from each noncompliant area to make the area compliant; and polishing the part using the abrasive strip, controlling the strip so as to remove the amount of material from each noncompliant area. The method can be used for example for polishing turbine engine fan blades.

The present invention relates to the field of the manufacture of components such as turbomachine blades using the forging technique, notably the precision forging technique. It relates more particularly to the manufacture of large fan blades in titanium alloy, such as turbojet engine fan blades and to the finishing of these blades to make the semifinished forged component geometrically compliant by using an adaptive polishing operation.

Turbojet engine fan blades are generally produced using precision forging. Precision forging involves striking successive blows to a rough form held in suitable dies until a semifinished component is obtained that has a shape and dimensional characteristics similar to that of the finished component. In the case of a forged semifinished fan blade, the airfoil does not comply, in terms of geometrical characteristics, with the final specifications, within accepted tolerance bands. These characteristics include for example the twist, which is a rotation of the sections of the airfoil along the stacking axis, the buckling which is a bending of the airfoil with respect to the stacking axis and the reference points, and ripple and shape defects.

The airfoil therefore has to be made compliant. Overall, this involves correcting the profile of the suction face side and of the pressure face side by removing material from those points of the airfoil where the thickness is greater than the theoretical profile. In the context of precision forging, the correction involves removing an excess thickness of up to a few tenths of a millimeter, generally of between 0.4 and 0.6 mm.

A number of points corresponding to the theoretical profile are determined, these points being distributed in a network along the axis of the airfoil and between the leading edge and the trailing edge. The geometric characteristics of the semifinished blade are measured at these points using three-dimensional sensor means. Patent EP 1596156 in the name of the applicant company describes such a means. The difference between the theoretical profile and the actual profile is thus determined.

According to the prior art, the next step is the thickness sorting operation, which involves analyzing and then protecting the thinnest zones of the component by applying a coating. This operation is performed chiefly by hand. The excess material is then removed, from between these protected zones, using chemical machining which involves keeping the component for a set length of time in a bath of acid capable of eating away at the metal. The out-of-tolerance zones which exhibit appearance defects and traces of the chemical machining are then manually reworked by local and repeated polishing. This operation is what is known as a first appearance polishing operation. By hand if necessary the component is tweaked until its shape falls within the prescribed tolerance band.

Finally, an automated polishing operation known as the final appearance polishing operation ensures the continuity of the aerodynamic profile and the surface finish necessary for the air to flow correctly. The automated polishing operation is generally performed using an abrasive belt. Use is made for example of a belt in which the abrasive material is silicon carbide. The belt is mounted on a wheel rotated tangentially with respect to the surface of the component. The movement of the wheel relative to the surface is controlled by a program that takes account of the geometry of the surface that is to be polished. Parameters such as the rate at which the abrasive belt travels across the surface, the rate at which the wheel travels with respect to the component and the pressure applied to the surface and the grit of the abrasive material are determined in such a way as to remove the required thickness of material and achieve the desired surface finish. A description of an abrasive belt polishing machine can be found in U.S. Pat. No. 5,193,314.

The manual operations, in particular when heavy components such as turbojet engine fan blades have to be worked on, are awkward for the operator and can potentially generate musculo-skeletal problems. Further, these operations have to be checked. There is a desire to replace manual operations with operations that free the operator and which allow several operations to be grouped into one. The applicant company has already developed a method for the automated polishing of titanium alloy using an abrasive belt made up of super abrasive grit made of industrial quality diamond or boron nitride; that method is described in EP 1525949.

The applicant company has set itself the objective of achieving geometric compliance and performing final polishing of the airfoil in one and the same step, and preferably automatically.

This objective is achieved using a method of manufacturing a component by forging, involving producing a semifinished component by precision forging and polishing the component using an abrasive belt, the nominal or compliant geometric characteristics of the component to be obtained being determined in a theoretical model, characterized in that it comprises the following steps:
measuring geometric characteristics of the semifinished component after the forging operations and comparing against the theoretical model,
determining, on the surface of the component, those zones which are non-compliant,
determining the amount of material to be removed in each non-compliant zone in order to make it compliant with the nominal geometric characteristics,
polishing the component using the abrasive belt, controlling said belt in such a way as to remove said amount of material in each non-compliant zone.

Because the machine is numerically controlled, a specific program for the component that is to be polished is generated.

In the prior art technique for achieving compliance, the automated polishing machines are used for the final appearance polishing, using an abrasive belt suited to the desired surface finish. In the prior art, a uniform thickness of material is removed so as not to destroy the profile that has been made compliant by hand in the previous operation; the manual step of achieving compliance is now eliminated and incorporated into the final polishing operation.

The advantages of achieving compliance in the way described by the invention, which can thus be made automatic, are that the manual operations of sorting, of masking those zones that do not need to be treated and of reworking the components are eliminated.

Time in the component manufacturing cycle is also saved.

A reduction in the geometric spread which is associated with the manual rework is also noted.

Finally, the risks of repetitive strain injury are also eliminated.

According to another feature, a plurality of measurement points is defined beforehand at the surface of the component, the geometric characteristics of the semifinished component are measured at least some of said measurement points, the removal of material by said abrasive belt is controlled at said measurement points on the basis of the discrepancy between the geometric characteristics of the semifinished component and the nominal geometric characteristics.

According to another feature, a map of the removals of material is defined from the measurements of the geometric characteristics of the semifinished component, and said map is converted into a map of the control parameters for controlling the abrasive belt.

For preference, the control parameters for the abrasive belt are calibrated beforehand for each of the measurement points. The calibration operation is performed just once for a given type of component.

According to a preferred embodiment of the method, the belt is controlled by varying the relative feed rate of the component with respect to the abrasive belt, with the other abrasive belt control parameters kept constant. The other parameters are the rotational speed of the abrasive belt and the contact pressure of the wheel against the surface that is to be treated.

Thanks to this feature of the method it is possible in an advantageous way to overcome the difficulty of polishing the surface of the component while at the same time making it geometrically compliant.

In the calibration phase, a relationship such as a law or a look-up table is established between the controlled parameters and the amount of material removed. For example it is possible to use a calibration which is performed on the basis of the measurement, at each point, of the amount of material removed associated with at least two different feed rates.

In order to ensure polishing that is uniform at all points, a minimum amount of material corresponding to uniform polishing is removed at each measurement point.

As has been set out hereinabove, the method applies in particular to a turbomachine blade, more particularly to a turbojet engine fan blade.

The invention will be better understood and other objects, details, features and advantages thereof will become more clearly apparent during the course of the detailed explanatory description which follows, of a non-limiting embodiment given with reference to the attached drawings, in which:

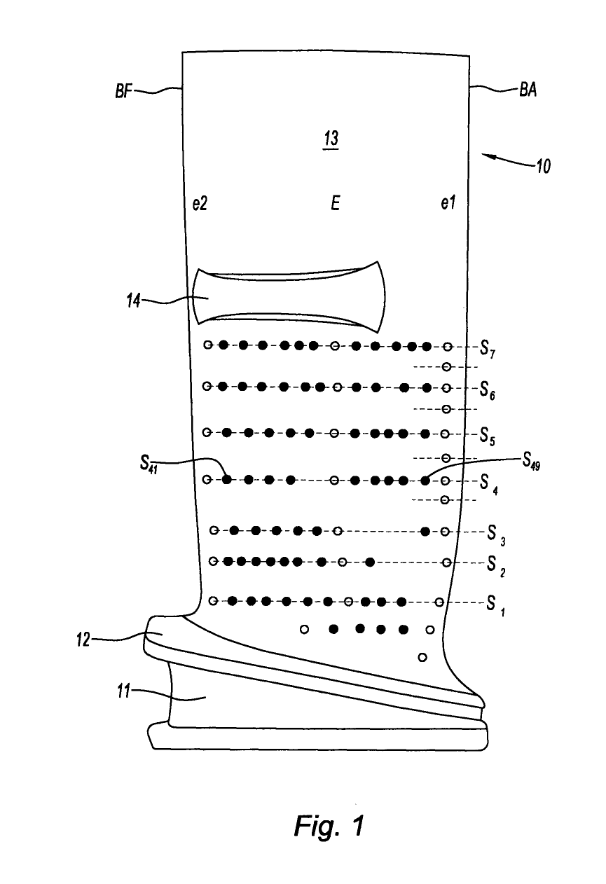

FIG. 1 schematically depicts a turbomachine blade, viewed in profile,

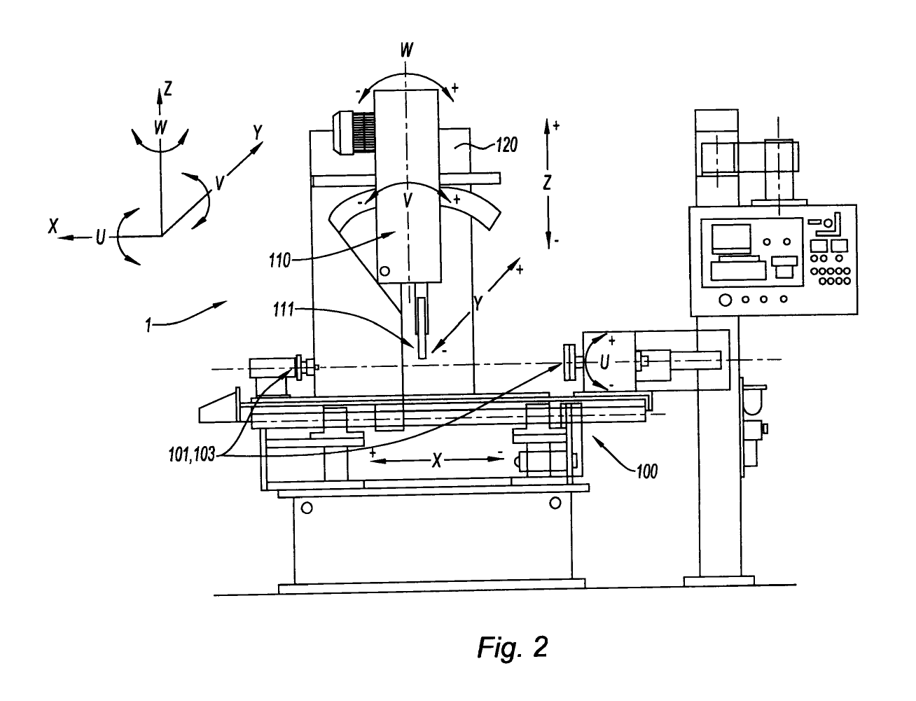

FIG. 2 depicts an abrasive belt polishing machine.

The semifinished component that forms the subject of the method of the invention is, for example, a turbojet engine fan blade as depicted in FIG. 1. Such a component 10 made of titanium alloy comprises a root 11, a platform 12 and an airfoil 13 of aerodynamic shape swept by the gases passing through the engine from upstream to downstream. Intermediate ailerons 14 form supports from one blade to another. Such a blade, when mounted on the compressor rotor, extends in the engine in a radial overall direction with respect to the axis of rotation of the moving parts of this engine. The airfoil comprises a pressure face side and a suction face side, running between the leading edge BA and the trailing edge BF along both of which they meet.

The contour of the airfoil is defined by a plurality of sections or cross sections extending between the platform and the tip, along an axis known as the stacking axis with respect to a reference system. The reference system is itself defined by elements or planes of the blade root. Thus, the blade is wholly geometrically characterized by knowledge of parameters associated with predefined points on each of the sections. This set of points constitutes the nominal geometric characteristics of the blade and forms the theoretical model. The nominal geometric characteristics can be defined in terms of dimensions, shapes, one or more coordinate(s) in space or else orientations or a combination of a number of these.

In the example depicted, that part of the airfoil that is situated between the platform and the pressure face aileron is defined by seven sections S1 to S7. In each of the sections, points on the surface of the airfoil between BA and BF have been identified. For example, the section referenced S4 comprises the points identified S41 to S49 between the trailing edge BF and the leading edge BA.

As in the method of the prior art, the starting point is to use a three-dimensional measurement robot to measure the geometric characteristics of the as-forged semifinished component.

The applicant company has described an example of a method and apparatus for simultaneously measuring the geometric characteristics of a plurality of points distributed over the surface of a blade in patent EP 1 596 156. The three-dimensional measurement of the coordinates of a set of predetermined points on the surface of a mechanical component with respect to a predetermined frame of reference involves:
a preparatory phase in which the coordinates of the predetermined points on the surface of a first mechanical component considered to be a calibration component are simultaneously measured,
an initializing phase in which the linear displacement measurements along the normals to the points of said calibration component are noted,
a measurement phase in which the linear displacement measurements on the points of the component that is to be measured that correspond to the points on the calibration component are noted,
a calculation phase in which the three-dimensional coordinates of the points of the component that is to be measured are calculated on the basis of the three-dimensional coordinates of the points of said calibration component, of the linear measurements and of the direction cosines of the theoretical normals at these points.

Using this calculation, which is performed at each of the measurement points on the predefined sections, it is possible to note the non-compliant regions, i.e. the regions which, for the points considered, have excess thickness. For each of the non-compliant zones, a value of how much material needs to be removed in order to make them compliant is obtained.

In the prior art, the following successive operations would then be carried out:
manual sorting,
chemical machining,
manual appearance polishing to eliminate appearance defects and traces of chemical machining, and
final appearance polishing in an automated polishing machine using a fine grit abrasive belt, suited to the desired surface finish and by means of which a uniform thickness of material is removed in order to achieve the required roughness without destroying the profile that has been made compliant by hand.

The method of the invention involves, having determined the thicknesses that need to be removed, creating a map of the removals of material and polishing in a machine, preferably an automated machine, with direct removal of material at each of those points that correspond to the established map, without passing through the step of manually achieving compliance. In fact, the surface of the blade is polished while at the same time making it geometrically compliant.

One example of a polishing machine which can be suitable for the invention is described hereinbelow with reference to FIG. 2.

The machine 1 illustrated in FIG. 2 is commercially available and supplied by IBS. A bed 100 comprises two jaws 101 and 102 between which the elongate component is held horizontal. The entire component with its mount can move in this direction X or be revolved on itself about this axis in the direction U by means of suitable electric motors Mx and Mu. Above the bed a head 110 is mounted on a vertical pillar 120 and can move along its axis Z. The head 110 can also rotate W about this axis Z. Suitable motor means Mz and Mw are provided for driving the head in the two directions. Finally, the head 110 can move horizontally in the direction Y which is perpendicular to the direction X and can pivot in the direction V about this axis. Motor means My and My provide for these movements. The head 110 supports a moving contact wheel 111 which can move about an axis which is fixed with respect to itself. A motor mounted on the head 110 drives the wheel 111 by means of an abrasive belt which is mounted at the periphery of the wheel. This collection of control means is connected to a control housing which contains a control unit with programming means and memories incorporating in particular the geometric characteristics data for the component that is to be polished.

To polish the component the belt is pressed locally and tangentially to the surface thereof, applying a determined pressure. The belt is set in movement and rotates with the wheel 111.

The amount of material removed and the surface finish are dependent on a number of parameters:
the grit of the abrasive belt,
the rate at which the belt travels as a result of the rotation of the wheel about its axis,
the pressure of the belt against the surface of the component as applied by the wheel,
the relative feed rate of the belt along the component which is the relative feed rate of the bed, i.e. of the component with respect to the tool in the direction of the X-axis.

According to another feature of the invention, the difficulty of polishing the surface of the blade while at the same time achieving geometric compliance is solved by controlling the relative feed rate of the component with respect to the polishing belt, preferably keeping the contact pressure and the belt rotational speed constant.

The machine is controlled on the basis of the map of material to be removed. It is converted, for the benefit of the machine, into a map of relative feed rate of the component with respect to the polishing belt. This map is devised on the basis of a pre-established relationship between the feed rate and the amount of material removed. Such a relationship is established by learning at each point on the component.

The learning phase is carried out just the once for a given type of component. According to one particular embodiment of the method of the invention it involves measuring, at each point on the component, the amounts of material removed associated with a plurality of uniform different feed rates. This yields the amount removed, by interpolation; one particular example involves determining the removal for two different feed rates.

To sum up, the various steps in achieving compliance of a component the nominal geometric characteristics of which are known, involve measuring its geometric characteristics and identifying which zones are non-compliant. On the basis of these measurements a map of the material to be removed for the points corresponding to these zones is established. These data are entered into the control box of the polishing machine 1. The component that is to be processed is placed between the jaws of the machine and the machine is set in action. The abrasive belt is driven in rotation by the wheel and brought into position against the component. According to one feature of the invention, the rotational speed of the wheel is kept constant throughout the polishing operation, as is the pressure of the wheel against the component. The feed rate of the belt along the component is controlled by the control box into which the above data has been input.

The feed rate thus varies according to the amount of material that is to be removed. The method thus allows the component to be made compliant and undergo final polishing all in a single pass. For preference, minimum removal of material is planned for the entire surface in order to achieve a uniform final polishing.

1-9. (canceled)

10. A method of manufacturing a component by forging, comprising:
producing a semifinished component by precision forging and polishing the component using an abrasive belt, compliant geometric characteristics of the component to be obtained being determined in a theoretical model;
measuring geometric characteristics of the semifinished component after the forging operations and comparing against the theoretical model;
determining, on a surface of the component, those zones which are non-compliant;
determining an amount of material to be removed in each non-compliant zone to make it compliant; and
polishing the component using the abrasive belt, controlling the belt so as to remove the amount of material in each non-compliant zone.

11. The method as claimed in claim 10, in which a plurality of measurement points is defined at a surface of the component, the geometric characteristics of the semifinished component are measured at least some of the measurement points, and removal of material by the abrasive belt is controlled at the measurement points based on a discrepancy between the geometric characteristics of the semifinished component and the nominal geometric characteristics.

12. The method as claimed in claim 11, in which a map of removals of material is defined from the measurements of the geometric characteristics of the semifinished component, and the map is converted into a map of control parameters for controlling the abrasive belt.

13. The method as claimed in claim 12, in which the control parameters for the abrasive belt are calibrated beforehand for each of the measurement points.

14. The method as claimed in claim 10, with the abrasive belt mounted on a support, and the component and the support configured to move one relative to the other, wherein the belt is controlled by varying relative feed rate of the component with respect to the abrasive belt, with the other abrasive belt control parameters kept constant.

15. The method as claimed in claim 13, with the abrasive belt mounted on a support, and the component and the support configured to move one relative to the other, wherein the belt is controlled by varying relative feed rate of the component with respect to the abrasive belt, with the other abrasive belt control parameters kept constant.

16. The method as claimed in claim 15, in which a relationship is established between the feed rate and the amount of material removed.

17. The method as claimed in claim 16, in which the calibration is performed on the basis of the measurement, at each point, of the amount of material removed associated with at least two different feed rates.

18. The method as claimed in claim 11, in which a minimum amount of material corresponding to uniform polishing is removed at each measurement point.

19. The method as claimed in claim 11, in which the component is a turbomachine blade, or a turbojet engine fan blade.
